(19) United States
(12) Patent Application Publication
(10) Pub. No.: US 2008/0058687 A1
(43) Pub. Date: Mar. 6, 2008

(54) Muscle rolling and pinching structure

(76) Inventor: Tzu-Keng Cheng, Chung-Ho City (TW)

Correspondence Address: TROXELL LAW OFFICE PLLC;SUITE 1404, 5205 LEESBURG PIKE, FALLS CHURCH, VA, 22041, US

(21) Appl. No.: 11/514,363

(22) Filed: Sep. 1, 2006

(51) Int. Cl. A61H 15/00

(52) U.S. Cl. 601/122; 601/123; 601/125

(57) ABSTRACT

A muscle rolling and pinching structure is provided. The structure includes a base, a holding device and a roller set, wherein the holding device is provided on top of the base, while the roller set is provided on the bottom of the base. Through the grip of the holding device and the handle connected to the grip, a user can easily operate the roller set on the base. The roller set pinches each muscle on the body during operation through the unique position of the rollers, thereby creating elastic built on the muscle and effectively maintaining the elasticity of the body muscle as well as achieving the objectives of convenience, comfort, durability and cost effective. The muscle rolling and pinching structure is indeed a practical invention.

### FIELD OF THE INVENTION

The present invention relates to a muscle rolling and pinching structure; in particular, the present invention relates to a unique assembly of the pinching structure of the roller set so as to pinch muscle naturally in operation, thereby achieving practical effects.

### BACKGROUND OF THE INVENTION

The conventional massager is structured mainly with electric massaging granules. Through the continuous vibration to pat each body part, tensed muscle can be relaxed so that a user can feel more comfortable. The structure of the electric massaging granules is not only complex in design but also expensive in cost. Although it comes with a variety of large and small designs or it is designed for a particular body part, it is hard to operate due to its basic electric structure. The mechanically and electrically assembled structure consumes energy. If it can be substituted with a non-electric massager, it may be able to solve the energy consumption problem; however, the user still feels tired after using it for a while. Furthermore, the conventional massager does not exercise the body muscle because muscle toning needs to pull and contract muscle, just liking using an exercise equipment that is designed for a particular body muscle for such purpose, causing continuous pulling and contracting of certain body muscle. Muscle can thus become elastic and built. The conventional massager can still be improved to create such muscle toning effect as well as to solve the energy consumption and manufacturing cost issues.

### SUMMARY OF THE INVENTION

The present invention provides a muscle rolling and pinching structure. The structure solves the functional limitation of the conventional massagers in a way that is low cost, and ease of use. It can also exercise muscle so as to satisfy the functional need users have on such massagers, achieving better utility.

The main object of the present invention is to provide a muscle rolling and pinching structure with a unique roller set, allowing the roller set to create pulling and contracting effect on a targeted muscle when the roller set of the muscle rolling and pinching device is in use. Therefore, the muscle is pinched and pressed to increase the effect of the device. At the same time, the user will not need to spend extra money on purchasing different types of massagers, thereby lowering the cost and increasing the utility.

Another object of the present invention is to provide a muscle rolling and pinching structure with a holding device such that the user can easily control the device and can use it at different body parts to achieve the ease of use.

In order to allow the examiner to better understand the technology, means and effects of present invention, the below description is accompanied with detailed drawings so as to describe the objects, characteristics and advantages of the present invention. However, it is understood that the drawings are used for reference and are not meant to limit the scope of the present invention.

### DETAILED DESCRIPTION OF THE DRAWINGS

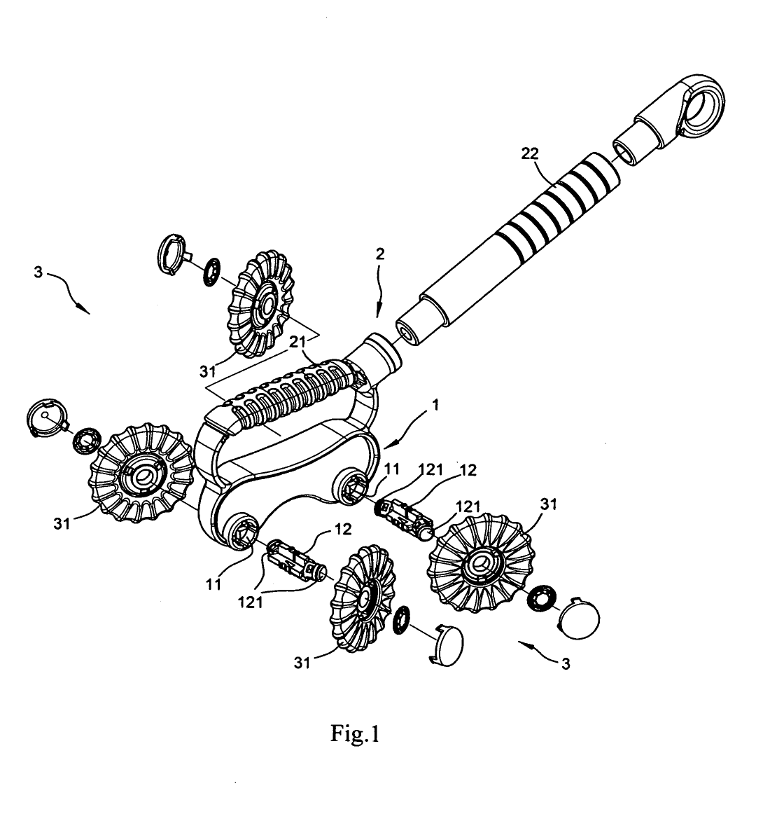

FIG. 1 is an exploded three-dimensional view of an embodiment of the present invention.

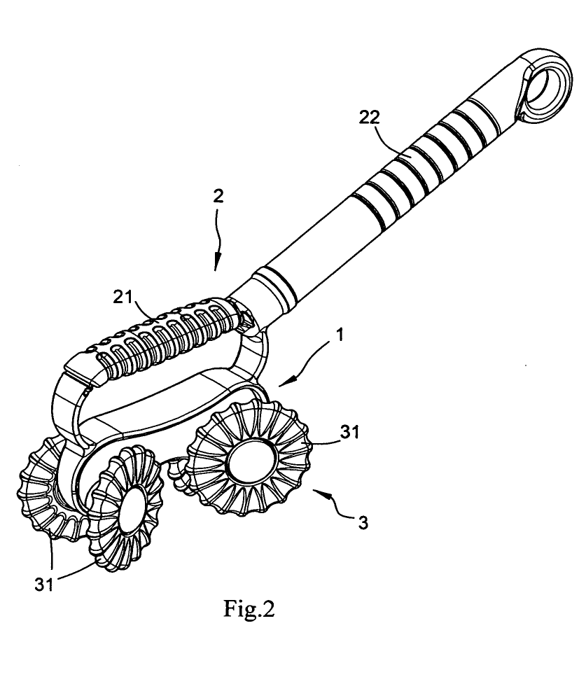

FIG. 2 is an assembled three-dimensional view of an embodiment of the present invention.

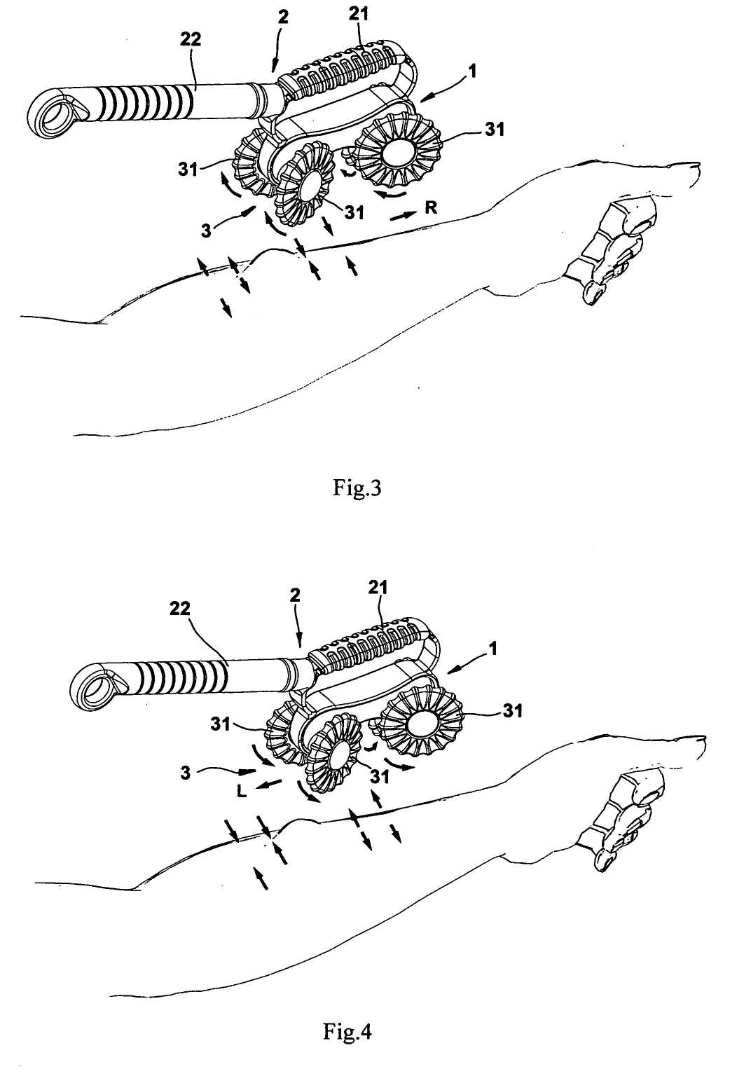

FIGS. 3 and 4 is a schematic view of an embodiment of the roller in use in accordance with the present invention.

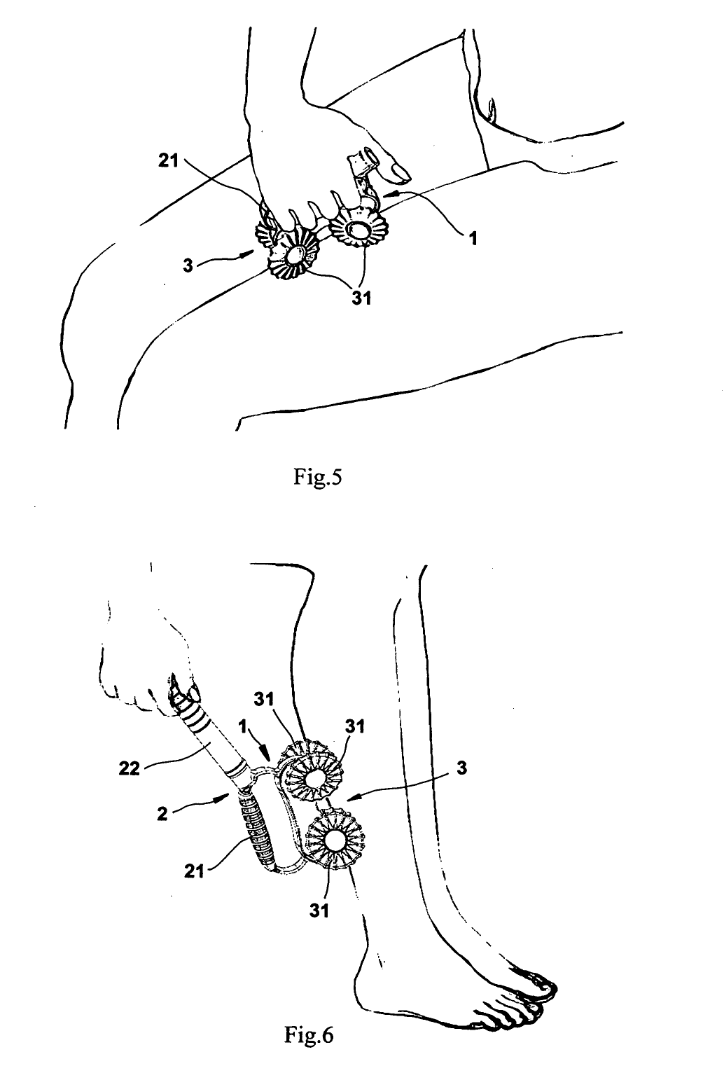

FIG. 5 is a schematic view of an embodiment of the roller set used at thigh in accordance with the present invention.

FIG. 6 is a schematic view of an embodiment of the roller set used at calf in accordance with the present invention.

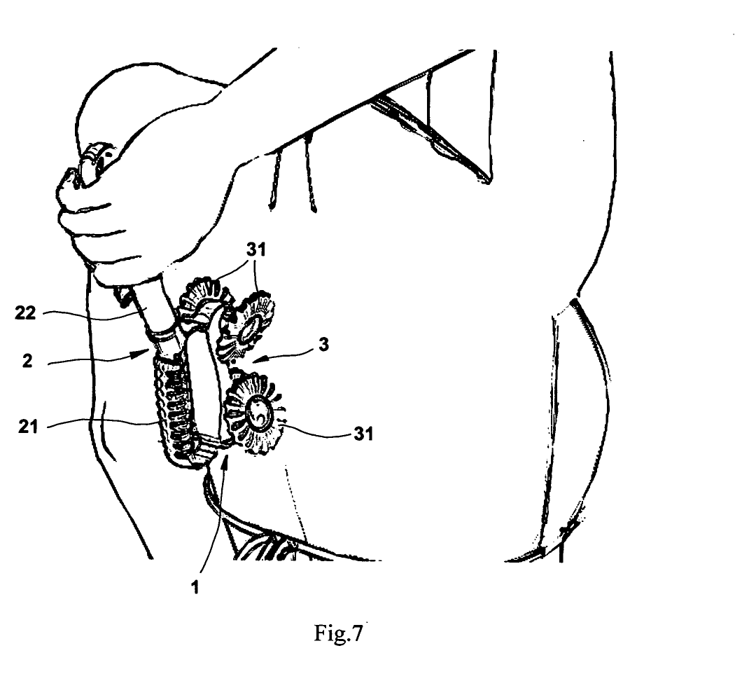

FIG. 7 is a schematic view of an embodiment of the roller set used at back in accordance with the present invention.

### DETAILED DESCRIPTION OF THE EMBODIMENTS

The structure and function of the present invention are now described in details with the accompanying drawings as follows. Refer to FIG. 1 which is an exploded three-dimensional view of an embodiment of the present invention. The muscle rolling and pinching structure includes a base (1), a holding device (2) and a roller set (3), wherein the bottom of the base (1) is provided with an aperture device (11). A shaft (12) is provided within the aperture device (11), and the axle center (121) provided on the two ends of the shaft (12) is used to set each roller (31) of the roller set (3). On top of the base is provided with a holding device (2), including a grip (21) on the base (1), and a handle (22) connected to the grip (21) so as to allow a user to easily operate the rolling and pinching structure through the holding device (2). What's worth mentioning is that the aperture (11) on the bottom of the base (1) is provided with the shaft (12), and the axle center (121) is provided on the two ends. The axle line of the axle center (121) is not on the same line as the axle line of the shaft (12). That is, an angle is between the two axle lines (12-121) such that when the axle center (121) is connected to the rollers (31), the shape of the rollers (31) at the two ends of the shaft (12) is tilted symmetrically with each other. Refer to FIG. 2 which is an assembled three-dimensional view of an embodiment of the present invention. It can be clearly seen that the tilted position of the rollers (31) at the two ends of the shaft (12) is formed with an opening roller set (3) at the bottom of the base (1). In the embodiment, the roller set (3) has 4 rollers (31), each set with two rollers formed at the front and back ends on the bottom of the base (1) with two opening roller sets (3). It is a uniquely positioned roller set (3) structure. When the user holds the holding device (2), whether at the grip (21) or the handle (22), the user can easily operate the base (1) so as to allow the roller set (3) to create special rolling and pinching effect.

Refer to FIGS. 3 and 4 which are the schematic view of an embodiment of the roller set in use in accordance with the present invention. As shown in FIG. 3, when the base (1) is pushed to the right (R), all rollers (31) of the roller set (3) create a clockwise rotation after contacting the body (as shown by the arrow in the drawing). The opening roller set (3) shape at the bottom of the base (1) allows the rollers (31) to rotate clockwise, so that the contacted muscle will follow the rollers (31) to be rolled and pinched from outside to inside (as shown by the arrow at the arm, from outside to inside). The clockwise rotation of the rollers (31) at the opening roller set (31) shape at the bottom of the base (1) allow the contacted muscle to follow the rollers (31) to be pushed from inside to outside (as shown by the arrow at the arm, from inside to outside). The corresponding operation of the front and back roller sets (3) creates the rolling and pinching effect at the contacted muscle. The pushing and relaxing muscle exercise may create muscle toning such that the muscle will gradually become elastic. In the long term, it can build the muscle with nice shape. Therefore, the rolling and pressing effect of the roller set (3) not only has massaging effect but also creates muscle toning under the unique rollers (31) structure, thereby increasing the utility of the device. Similarly, when the base (1) is pushed to the left (L), all the rollers (31) perform a counter clockwise rotation at the contacted area. The rolling and pinching effect of the muscle is contrary to the effect mentioned above. The roller set (3) at the front end of the base (1) allows the muscle to follow the rollers (31) to be pushed from inside to outside (as shown by the arrow at the arm, from inside to outside). The roller set (31) at the back end on the bottom of the base (1) will allow the contacted muscle to follow the rollers (31) to be pushed from outside to inside (as shown by the arrow at the arm, from outside to inside). Therefore, by pressing back and forth, the device can effectively roll and pinch the muscle to help tone it. At the same time, the flange of the shape of the rollers (31) is formed with concave and convex curves. During rolling and pressing, massaging effect is provided. Therefore, it is low cost and consumes no energy. The present invention indeed improves the utility of the device.

Additionally, with respect to the holding device (2) on top of the base (1), the handle (22) can be detached from the holding device (2) such that the user can hold onto the grip (21) of another holding device (2). It may be suitable for rolling and pressing different body parts of the use. As shown in FIG. 5, the user can operate the device on his/her thigh, and will not have the problem of having a long handle (22). When the user operate the device on his/her calf or back, the handle (22) can be attached to the end of the grip (21) so that the user can easily hold the handle (22) to perform the rolling and pressing, as shown in FIGS. 6 and 7.

Therefore, the present invention is a unique product with novelty, and it is not obvious. The present invention completely satisfies the requirement for granting a patent in accordance with the patent law; therefore, a grant of patent is respectfully requested so as to protect the invention.

It is to be noted that the detailed description and the accompanying drawings are a preferred embodiment of the present invention. The characteristics of the present invention are not limited to the embodiment. The embodiment is not meant to limit the scope of the invention. The scope of the present invention shall be set forth in the appended claims. All modifications are equivalents thereof shall be included in the scope of the invention.

What is claimed is:

1. A muscle rolling and pinching structure, comprising a base, a base, a holding device and a roller set, wherein
said base has a upper portion and a lower portion, said lower portion has an aperture device with a shaft provided therein;
said holding device is provided on top of said base;
said roller set includes a plurality of rollers provided on the bottom of said base, and the shape of said rollers is symmetrically tilted with each other.

2. The muscle rolling and pinching structure of claim 1, wherein said shaft provided on the bottom of said base is provided with axle center device at the two end thereof, an axle line of said axle center is not on the same line as an axle line of said shaft, meaning the two axle lines has an angle.

3. The muscle rolling and pinching structure of claim 1, wherein said holding device is included on a grip of said base, and a handle connected to an end of said grip.

4. The muscle rolling and pinching structure of claim 1, wherein said shape of said roller set is symmetrically tilted, and an end at the bottom of said base has an opening shape.

5. The muscle rolling and pinching structure of claim 4, wherein said shape of said roller set is symmetrically tilted, and a front and a back end at the bottom of said base has an opening shape respectively.

6. The muscle rolling and pinching structure of claim 4, wherein a flange of said shape of said roller set is formed with concave and convex curves.
